(19) United States
(12) Patent Application Publication
(10) Pub. No.: US 2009/0033107 A1
(43) Pub. Date: Feb. 5, 2009

(54) Door closing mechanism

(76) Inventors: Gunther Zimmer, Rheinau (DE); Martin Zimmer, Rheinau (DE)

Correspondence Address: KLAUS J. BACH, 4407 TWIN OAKS DRIVE, MURRYSVILLE, PA, 15668, US

(21) Appl. No.: 12/220,066

(22) Filed: Jul. 21, 2008

Related U.S. Application Data
(63) Continuation-in-part of application No. PCT/DE2007/000130, filed on Jan. 22, 2007.

(30) Foreign Application Priority Data
Jan. 21, 2006 (DE) 10 2006 002 952.6

(51) Int. Cl. E05C 19/06

(52) U.S. Cl. 292/302

(57) ABSTRACT

In a door closing mechanism for a hinged door arranged in a door frame, comprising a door fixture mounted to the door frame, a final door closing pull arrangement disposed in the door- or the frame fixture and a door closing pull arrangement counter part mounted on the frame, or respectively, the door fixture, the final door closing mechanism includes a catcher with a closing pull element which is moved toward a front position in which it is retained. A closing pull mechanism counter piece has a trigger element with which the closing pull element comes directly or indirectly into contact during door closing for pulling the to a closed position.

The invention relates to a door closing mechanism for a hinged door arranged in a door frame which mechanism comprises a door fitting disposed on, or in, the door panel, a frame fitting arranged in, or on, the door frame, a final door closing movement arrangement which is disposed in the door fitting or in the frame fitting and a final door closing movement counterpart which is mounted to the frame fitting or, respectively, the door fitting.

In a brochure concerning folding door closers of Gretsch-Unitas GmbH, 71254 Ditzingen, dated Oct. 17, 2005, a door closer is described which is accommodated in the door panel area. To this end, a fitting including a closing spring acting on a lever drive is installed in a cut-out of the door panel. The lever drive output is a lever end to which a coupling rod is pivotally connected. The coupling rod is connected at its free end cardanically to a fixed point of the door frame. For closing the door, the lever pivots into the fitting while pulling the door into a closed position. However, a full closing of the door is not always ensured since the force of the closing spring is smallest specifically at the end of the closing path. Also, simple unhinging of the door is no longer possible.

It is the object of the present invention to provide a final closing mechanism for a hinged door which starts to pull the door to its closed position as soon as a fitting part of the door comes into contact with a fitting part of the door frame or a fitting part of the wall supporting the door.

This object is solved by the features of the main claim. To this end, the final door closing mechanism includes a closing catcher to which a closing pull element is connected or linked. The closing catcher is supported in a fitting and is moved along the fitting to a forward position in which it is held. The closing mechanism counterpart includes at least a tripping element which comes directly or indirectly into contact with the closing pull element when the door is being closed in order to fully close the door by a push movement of the closing catcher in combination with the closing pull element.

The closing catcher may be provided with at least one braking surface for damping the closing movement. The final closing pull mechanism includes to this end a pneumatic or hydraulic damping member which is arranged between the closing catcher and the fitting. The trip element has at least one contact flank which comes directly or indirectly into contact with the braking surface when the door is closed in order to slow down the movement of the door panel by an activation of the damping member.

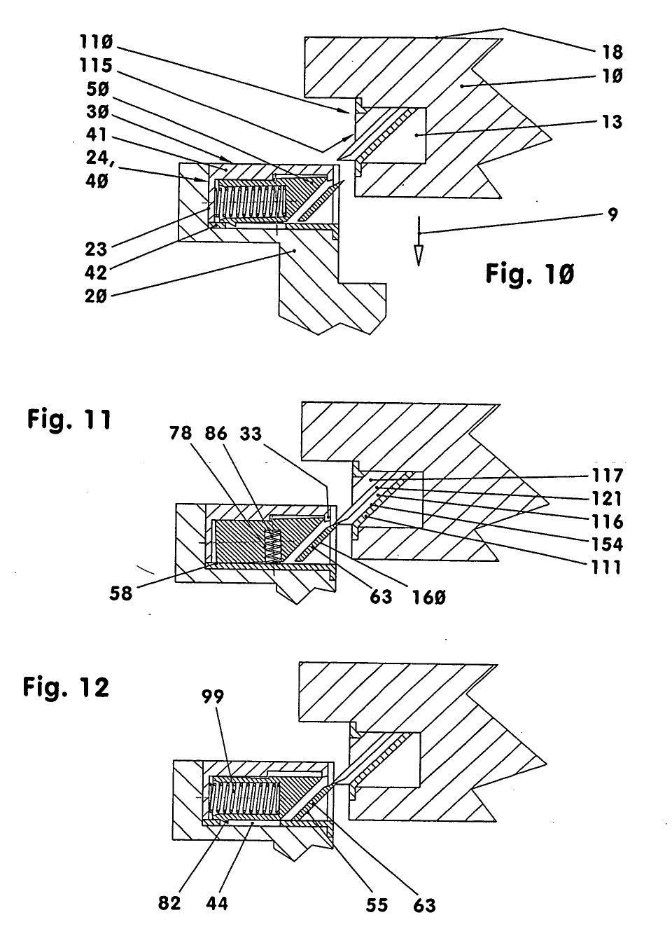

This final closing mechanism is only activated when the slowed-down door is almost closed. As soon as the lock fitting of the door panel comes into contact with the door frame, the final closing pull mechanism is activated. Then the front edge of the lock fitting is—depending on the wall thickness of the door panel—at a distance from the door frame seal of only about 10-25 millimeters as shown in FIG. 11. With this final closing pull mechanism, a so-called door shattering caused for example by air drafts can be avoided. Already with a first contact between the exposed fitting parts, a rapid and secure closing of the door is initiated. The secure closing is based on the operation principle. After all, the catcher or an associated lever drive pulls the door to the closed position over the final closing distance. In this way, a weak point of the insertion locks according to DIN18251 is avoided. With those locks, it happens quite often that the catcher does not enter the catcher opening but only abuts, with its front edge, the cover plate in a quasi-stable or, respectively, non-locking manner. Then, doors with such standard insertion locks may again be opened when pushed slightly or by leaning against the door.

In various embodiments, the final closing pull arrangement is integrated into a lock box which is installed in a door panel. But it may also be integrated into the fitting of a door frame. In that case, the trigger elements are mounted in, or on, the door panel.

The door closing mechanism closes any door whose movement is initiated for example by the type of the door mount. For initiating the closing movement, the pivot axis of the door panel may be slightly inclined with respect to the frame. Also, the facing front surfaces of the door hinges may extend helically around the post. Furthermore, the door panel may be supported on the door frame by way of a lifting rod arranged near the door pivot axis. In all three cases, the weight force of the door panel is used for closing the door. Alternatively, a floor door closer, an automatic door closer or a spiral spring accommodated in the door hinge in a tightened state may be used. These variants provide for the closing movement by way of pre-tensioned mechanical springs.

Further particulars of the invention are apparent from the sub-claims and the following description of schematically shown embodiments:

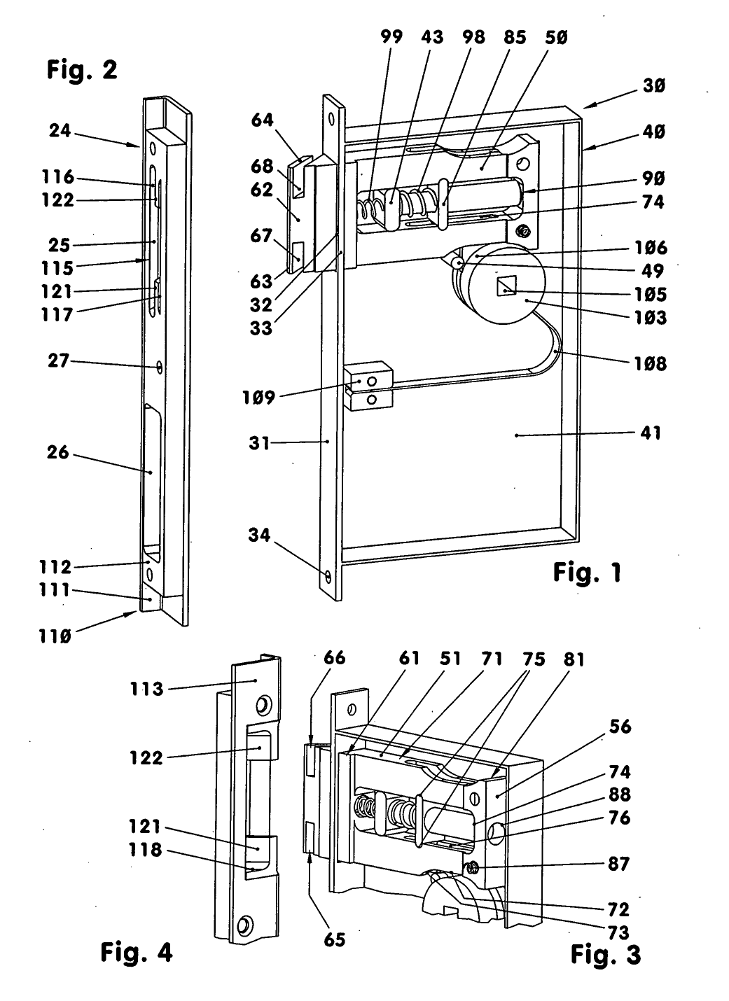

FIG. 1: perspective view of a closing pull mechanism including a damper;

FIG. 2: perspective view of a closing pull counter element;

FIG. 3: another partial view of FIG. 2;

FIG. 4: another partial view of FIG. 2;

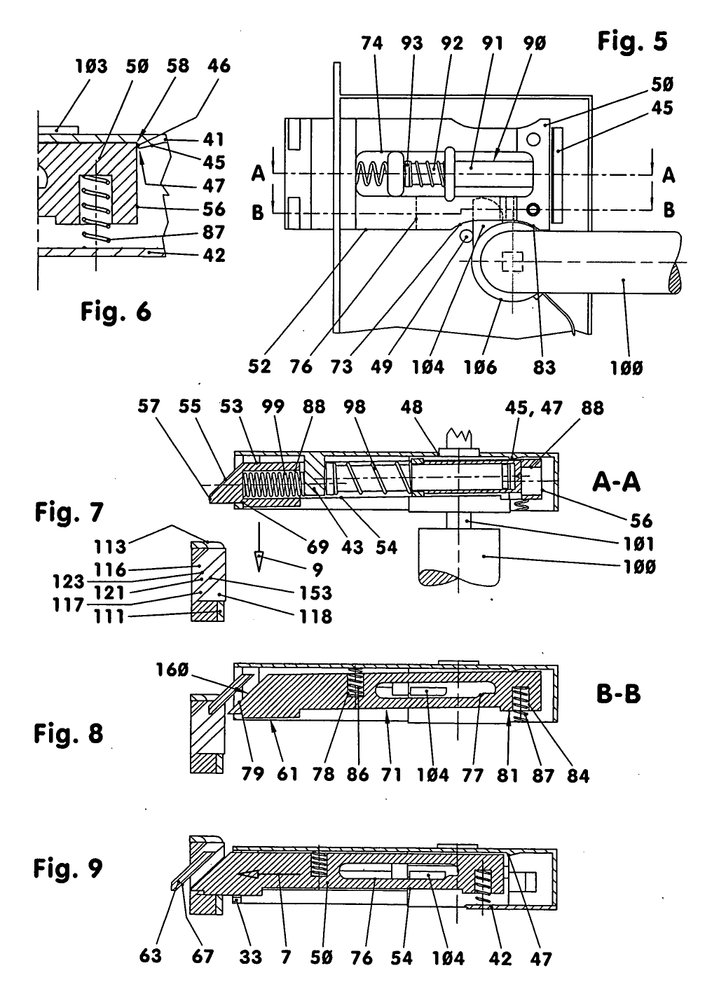

FIG. 5: a partial side view of FIG. 1;

FIG. 6: rear closing pull mechanism with the closing pull catcher extended;

FIG. 7: cross-sectional view of a damped door closing pull mechanism with the door open;

FIG. 8: the same as FIG. 7, wherein however the door is in contact with the frame;

FIG. 9: cross-sectional view or the damped door closing arrangement with the door closed;

FIG. 10: cross-section through a door closing pull mechanism with a closing pull catcher arranged in the door frame in an open door position;

FIG. 11: like FIG. 10, the door however being in contact with the frame;

FIG. 12: like FIG. 10, but during closing pull catcher release;

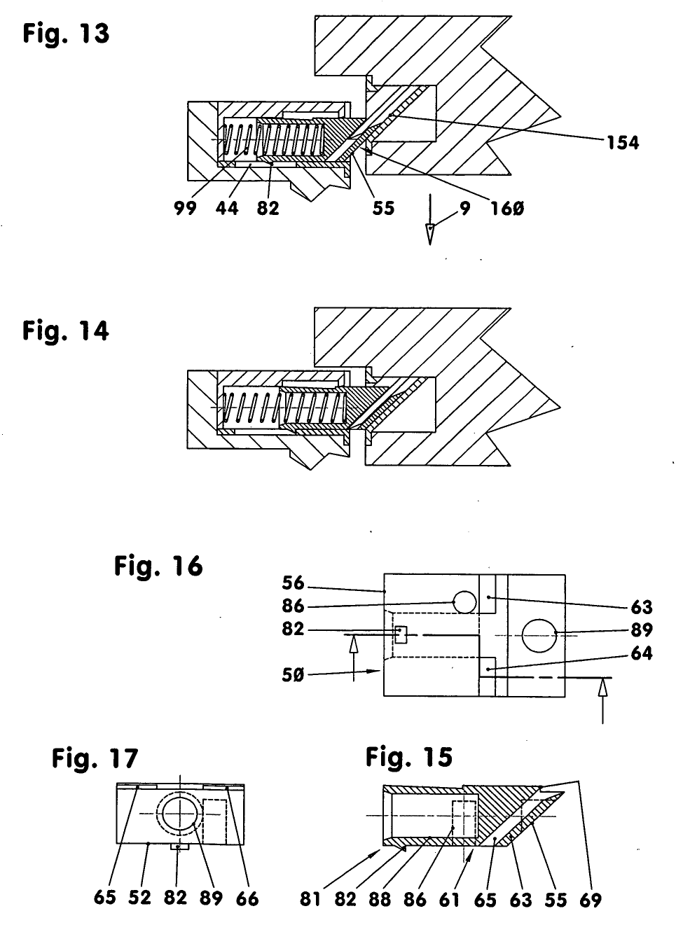

FIG. 13: like FIG. 10, but with the door almost closed;

FIG. 14: like FIG. 10, but with the door closed;

FIG. 15: longitudinal cross-sectional view of the closing pull catcher of FIG. 10;

FIG. 16: bottom view of FIG. 15;

FIG. 17: front view of FIG. 15;

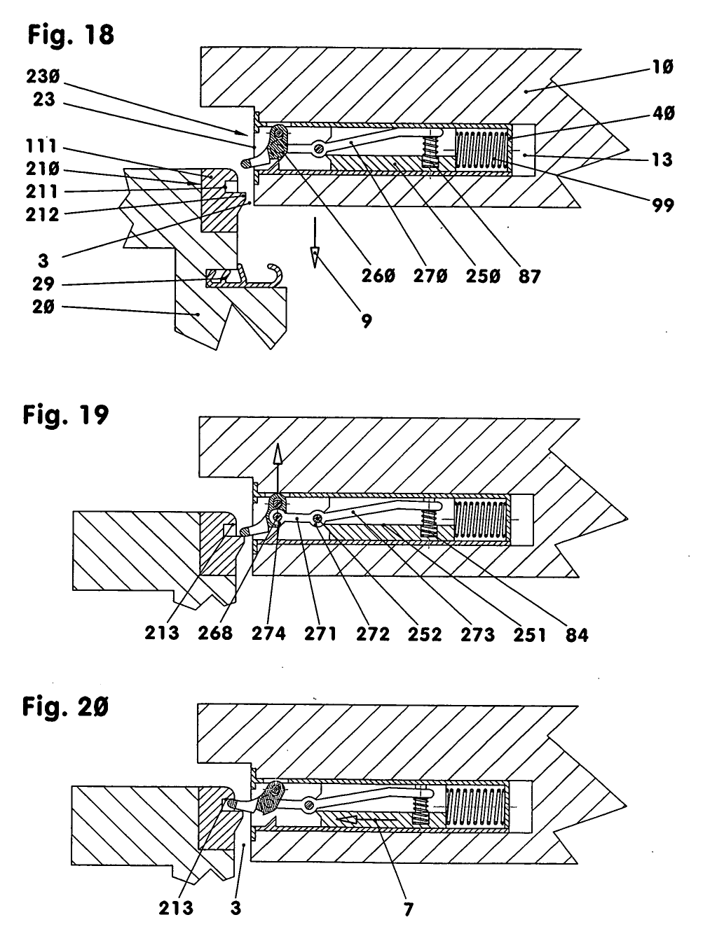

FIG. 18: closing pull mechanism with lever drive with the door coming into contact with the frame;

FIG. 19: like FIG. 18, but with the drive being unlocked;

FIG. 20: like FIG. 18, but with the door being almost closed;

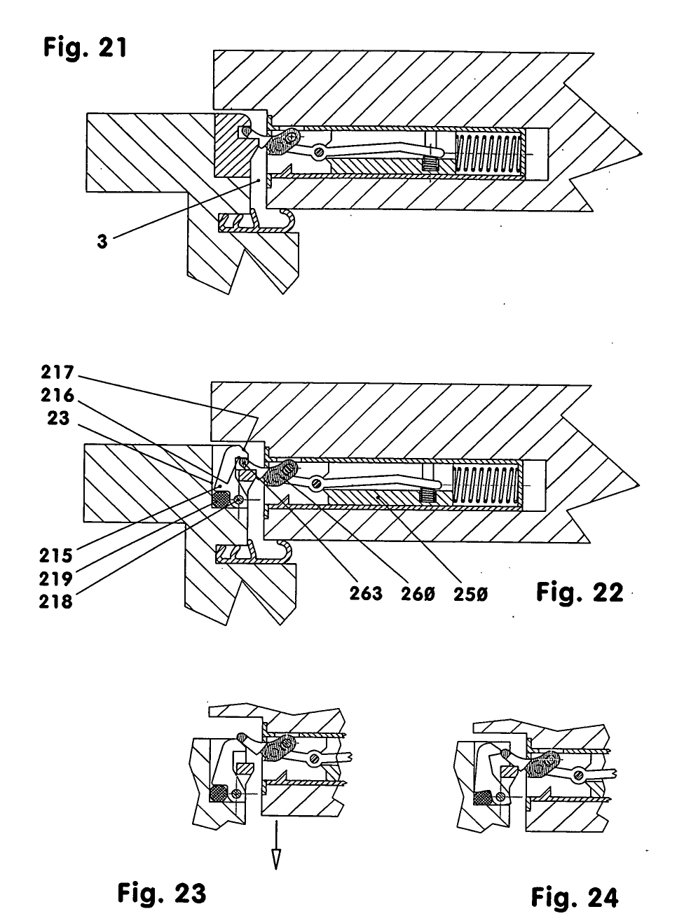

FIG. 21: like FIG. 18, but with the door closed;

FIG. 22: like FIG. 21, but with a movable lever as a closing catch element;

FIG. 23: like FIG. 22, but with the closing catch lever released;

FIG. 24: like FIG. 23, but with the closing catch lever released;

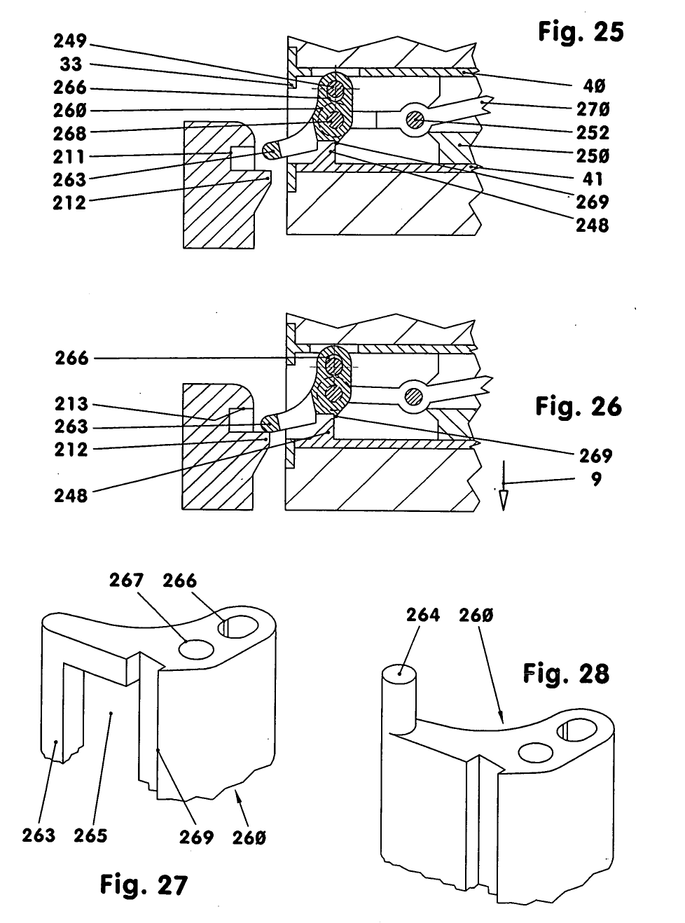

FIG. 25: enlarged sectional view of FIG. 18;

FIG. 26: enlarged sectional view of FIG. 19;

FIG. 27: closing pull lever without pin, shown only partially;

FIG. 28: closing pull lever with pin shown only partially;

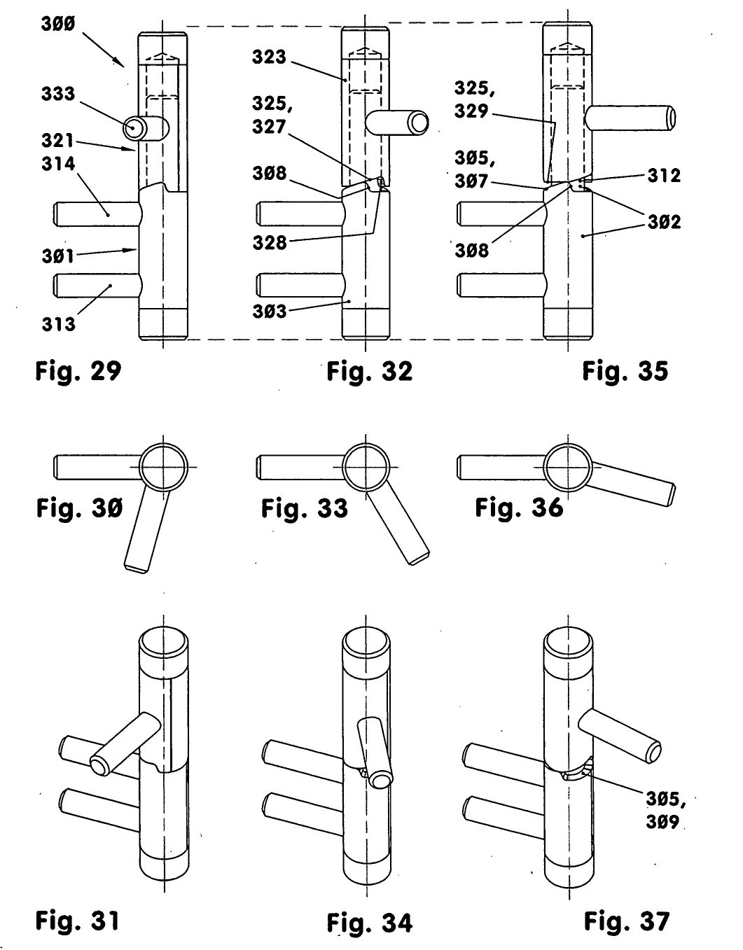

FIG. 29: door bound with the door in a closed position;

FIG. 30: top view of FIG. 29;

FIG. 31: perspective view of FIG. 29;

FIG. 32: door bound in a half-way open door position;

FIG. 33: top view of FIG. 32;

FIG. 34: perspective view of FIG. 32;

FIG. 35: door bound in an open-door position;

FIG. 36: top view of FIG. 35;

FIG. 37: perspective view of FIG. 35.

The FIGS. 1, 3 and 5 show the final door closing pull mechanism (30) as it is installed for example in the door panel, see FIG. 18, of a revolving or, respectively pivot door (1). The final door closing pull mechanism (30) comprises as housing a lock box (40) which is mounted to the door panel (10) for example by way of a cover plate (31). The cover (42) of the lock box (40) is shown in FIG. 9.

In this embodiment, a closing pull catcher (50), a nut (103) and a chain spring (108) with its support (109) are arranged in the lock box. The closing pull catcher (50), which is shown in the upper part of the lock box (40) is positioned above the pivot nut (103). The nut (103) is moved by a handle (100), (see FIGS. 6 and 7). The chain spring (108) is arranged below the pivot nut (103).

The closing pull catcher (50) can be divided into three sections. The first section is the head section (61). The latter is accommodated with play in, for example, the rectangular catcher opening (32) of the cover plate (31). The front area of the head section (61) is for example wedge-shaped. Its front surface (55) extends at an angle with respect to the lock bottom side (53) of, for example, 45°. A normal line on the front surface (55) extends opposite to the direction (9) of the door closing movement, that is, the front face (55) faces the overlap (11) of the door panel (10), see FIG. 11, and is not facing away therefrom as it is known from DIN 18251.

The head section (61) has near the front surface (55), for example, two groove-like recesses (65, 66). In each case, one of the recesses (65, 66) ends at the upper side (51) and the lower side (52) of the closing pull catcher (50). Each recess (65, 66) has a wall (67, 68) extending with respect to the lock bottom side (53) at an angle of for example, 45°. In the embodiment according to FIGS. 1-9, those walls (67, 68) are, for example, at least almost parallel to the front surface (55). Between the individual walls (67, 68, 167, 168) and the front surface (55), in each case, a braking web (64, 64) is formed. The walls (67, 68) form the braking surfaces of the braking webs (63, 64) whereas the walls (167, 168) form the closing pull flanks pull flanks, The range of the braking element (50) is, in this case, called a closing pull element (160). The recesses (65, 66) have in accordance with FIGS. 1, 3, 5 and 8-15, the shape of a rectangular groove.

The head section (61) is provided at the lock bottom side (53) of the closing pull catcher (50) with an engagement ledge (69), see FIGS. 7 to 9. The closing pull catcher in this way becomes wider behind the front edge (57) by for example one millimeter.

The second section is the center section (71). It has, at least in the rear area near the pivot unit (103), a cutout (72) with two flanks (73, 83) of partial cylindrical shape, see FIGS. 3 and 5. The front flank (73) serves as the rear stop for the closing pull catcher (50) whereas the rear flank (83) which is part of the foot section (81) is the front stop for the closing pull catcher. The flanks (73, 83) come into contact with cylindrical outer wall (106) of the pivot unit (103) to be stopped.

The center section (71) furthermore includes an elongated damper opening (74) which includes foam lock bottom side (53)—see FIG. 8, to the lock cover side (54). A damper (90) and a spring element (98) are arranged within the elongated damper opening (74) has in its center area two opposite grooves (75), in which a support plate (85) for, among others, supporting the damper (90) in a support plate bore are accommodated. Transverse to the elongated damper opening (74) the center section (71) the center section includes an elongated cam opening (76) which connects the elongated damper opening (74) with the catcher bottom side (52). The cam (104) of the operating unit (103) extends into the elongated cam opening (76), see FIGS. 5, 8 and 9. In its rear area, the elongated cam opening (76) is provided with a ramp-like step (77).

Between the elongated cam opening (76) and the head section (61), there is in the center section (71) on the lock bottom side (53) a dead end bore (78) in which a compression coil spring is disposed so as to form a front engagement spring (86). The front engagement spring (86), which is supported on the lock bottom (41), biases the closing pull catcher (50) toward the edge of the catcher opening (25), see FIGS. 8 and 9.

The foot section (81) is provided near the rear flank (83), at the cover side thereof, see FIG. 5, with a dead end bore (84). The latter accommodates a coil compression spring (87) as a rear engagement spring, see FIGS. 7-8. This engagement spring (87) is supported on the lock cover (42), see FIGS. 6 and 7.

In place of the coil compression springs (86, 87) also flat leaf springs may be used which, dependent on their installation position, slide along the lock bottom (41), the lock cover (42) or the closing pull catcher (50).

From the foot section (81), for example, a central dead end bore (88) extends up to the head section (61). Within, the spring element (99) is disposed. It is supported between the base of the dead end bore (88) and a guide web (43) of the lock box. If expedient, several springs arranged in parallel are installed in the head section (61).

The lock box (40), which is for example an oblong thin-walled sheet metal box, a closing pull catcher (50) is supported so as to be longitudinally movable. The extended closing pull catcher (50) see FIGS. 1 and 5, is guided, at one hand, in the catch opening (32) of the cover plate (31). At the other hand, the elongated walls of the elongated damper opening (74) abut the guide web (43) which is attached for example to the lock bottom (41) or is formed thereto.

In FIG. 5, behind the extended closing pull catcher (50), the stop web (45) is visible. The latter is shown in FIG. 6 in cross-section. It includes a locking flank (46) which extends toward the cover plate (31). The area of the locking flank (46) extends at least essentially vertically with respect to the lock bottom (41) and transverse to the direction of movement (7, 8) of the closing pull catcher (50).

Spatially below the cut-out (72) of the closing pull catcher (50) the pivot nut (103) is disposed in a bore (48) of the lock bottom (41). Near the pivot nut (103), see FIGS. 1 and 7, there is a central squared opening (105) in which the square bolt (101) of an operating handle is accommodated in a form-locking manner. A so-called chain spring (108) extends into the operating nut (103) and is fixed at its end remote from the operating nut in a spring support structure (109). The chain spring (108) pivots the operating nut (103) in a counter-clockwise direction as seen in the view of FIGS. 1, 3 and 5. Between the operating nut (103) and the cover plate (31) a stop bolt (49) is provided.

By way of the cover plate (31), that is, the front wall of the lock box (40), the lock box (40) is inserted into a cut-out (13) of the door panel (10) and is mounted therein, see FIGS. 18-22.

In FIG. 2, a frame fixture (24) is shown as the pull-to close counter piece (110). The frame fixture (24) consists of an angled locking sheet (111) and an integrated catcher engagement element (112). Both parts (111, 112) are rigidly interconnected. The catcher engagement element (112) has a closing pull recess (115) by which, upon closing of the door, the closing pull catcher (50) is engaged. Below this catcher opening (25) and the recess (115), there is another opening (26) into which for example a locking bolt extends during locking of the door.

The recess (115) comprises mainly narrow parallel grooves (116, 117). Both grooves extend at an angle of 45° with respect to the front face (113) of the angled locking metal sheet (111). The flanks of the two grooves (116, 117) extend for example at least approximately parallel to the front face (55) of the closing pull catcher (50), see FIG. 7. The web which is disposed between the two grooves (116, 117) is cut out in the center area of the recess (115) so that in the upper and the lower area of the recess (115), two tongue-like actuating elements (121, 122) remain. The tongue walls of the groove (116), see FIG. 7, form contact flanks (123), whereas the tongue walls of the groove (117) are support flanks (123).

The groove (117) has at the catcher side additionally a cut-out (118) of triangular cross-section, see FIG. 4, which provides for space for the front section (61) of the closing pull catcher (50).

FIG. 7 shows the frame fixture (24) and the lock box (40) with the retracted closing pull catcher (50). The elongated damper opening (74), see FIGS. 1, 3 and 5, is disposed between the support plate (85) and the right side end of the elongated opening (74) of the cylinders (91) of the damper (90). Expediently, the support plate (85) is part of the damper (90). The piston (92) which for example has no piston rod comprises a piston front plate (93) to provide for support on the guide web (43) of the lock box (40). The front surface of the front plate (93) of the piston is spherically curved to this end. Between front plate (33) of the piston and the support plate (85), a coil compression spring (98) is disposed on the piston (92) for biasing the piston (92) to its extended position, see FIGS. 7 and 8. The spring rate of the spring element (98) is substantially smaller than the spring rate of the spring element (99).

In accordance with FIGS. 7 and 8, the closing pull catcher (50) is engaged in its retracted position. To this end, the closing pull catcher (50) is disposed with the lock bottom side (53) on the projecting engagement edge (47) of the web-like stop (45), see FIG. 6. It is biased against this edge (47) by means of the engagement spring (87) of the foot section (81) supported on the lock cover (42). By the head section (61), the closing pull catcher (50) abuts the web (33) of the cover plate (31) via the engagement ledge (69). It is biased toward the web (33) of the cover plate (31) by an engagement spring (86) arranged in the center section (71).

When now, upon closing of the door, the lock box disposed in the door panel moves with the closing pull catcher (50) retracted toward the angled locking sheet (111) and the catcher engagement element (112) of the door frame (20) in the door closing direction (9), first, in accordance with FIG. 8, the braking web (63) with the braking surface (67) comes into contact with the engagement flank (123) of the release element (121), see FIG. 9. Herein, the brake web (63) projects from the lock box (40) just to such an extent that the braking surface (67) of the closing pull catcher (50) overlaps the engagement flank (123) of the frame fixture (24), for example, by 0.5-3 millimeter.

By the contact, the closing pull catcher (50) is pivoted around the engagement edge (47) forming a fictive pivot axis counter to the pivot movement of the closing door, for example by an angle of 1 degree. By the pivot movement, the engagement ledge (69) is moved off the cover plate edge (33). The locking of the closing pull catcher (50) is eliminated. Via the spring element (99), the front section of the closing pull catcher (50) is moved out of the lock box in a damped manner. The closing flank (79) which is part of the closing-pull element (160) abuts the support flank (153). Both flanks (79, 153) are in the shown exemplary embodiment wedge surface which slide along one another as parts of a wedge drive. The closing pull flanks (79) and/or support flanks (153) can be coated with slip-coatings which have low friction coefficients.

When a door closes slowly, the outward movement of the closing pull catcher (50) provides a force which pulls the door panel (10) fully into the lock. In this process, the lock bottom side (53) of the closing pull catcher (50) slides along the engagement edge (47) of the stop (45) until the rear end surface (56) is disposed in front of the blocking flank (46) of the stop (45), see FIG. 6. In front of the blocking flank (46) the rear bottom edge (58) of the closing pull catcher (50) is pressed via the engagement spring (87) against the lock bottom (41) where it is retained. The closing pull catcher (50) is then locked and the door is fully closed.

If the door panel (10) is closed at a larger speed, for example if the door is rapidly closed with an impulse, the braking webs (63, 64) with braking surfaces (67, 68) slide along the contact flanks (123) of the trigger elements (121, 122) for braking the door. The movement is damped by the damper (90). In this case, the closing flanks (79) abut the support flanks (153) only when the movement of the door has been largely braked down.

The damper (90) may also be a pure friction damper. If desired, also several different damper operating principles may be realized in the damper (90).

The braking surfaces (67, 68) and/or the contact flanks (123) can be provided with special braking pads on brake pad coatings.

With the aid of rolling bodies, the slide movements between the slide friction pairings lock box (40)/closing pull catcher (50), closing pull flank (79)/support flank (153) and/or front surface (55)/support flank (154) can be converted to roller friction. Expediently in each of the pairings closing flank (79)/support flank (153) and/or front side (55) support flank (154) at least one flank is rounded spherically curved.

In order to again open the door, the handle (100) must be pushed down. Upon operating the handle (100), the nut cam (104) is pivoted clockwise in the elongated cam opening (76) see FIG. 5. In accordance with FIG. 9, the nut cam (104) contacts in the elongated cam opening (76) the release ramp (77). In this way, the closing pull catcher (50) is raised from the lock bottom (41) above the engagement edge (47) of the stop (45) whereby it is moved again to the rear position by the force of the spring element (99).

FIGS. 10-14 show a closing pull arrangement wherein the final closing pull arrangement (30) is arranged in the door frame (20) whereas the closing pull arrangement counter part (110) is integrated into the door panel (10).

In the door frame (20), the frame fixture (24) of the arrangement (30) is disposed in a recess (23). This frame fixture (24) is, in this case, a lock box (40). In the lock box (40) the closing pull catcher (50) is supported and guided between a lock box bottom (41) and a lock box cover (42).

The closing pull catcher (50) has a head section (61) which corresponds to a large extent to the variant as shown in FIGS. 1-9, see FIGS. 15-17. It comprises a braking web (63, 64) and an engagement ledge (69). The front surface (55) includes a stepped bore (89). Near the head section (61), there is also a dead end bore (78) for accommodating an engagement spring (86). Next to the head section (61), there is a foot section (81). The latter includes a central dead end bore (88) for accommodating the spring element (99). The bore (88) extends to the rear surface (56). At the bottom side (52) of the catcher, there is a stop hook (82) which reaches into an elongated opening (44) of the lock cover (42).

The angled locking sheet (111) is disposed in a recess (13) of the door panel (10). It includes a closing pull catcher opening (115) which is at least essentially in the form of the closing pull catcher opening of the variant shown in FIGS. 1-9. Also here, tongue-like release elements (121) are arranged between the grooves (116, 117), see FIG. 11.

Upon closing of the door, the door panel (10) moves in the direction (9) toward the door frame (20). The release element (121) projecting beyond the flange surface of the locking sheet (111) comes into contact with the braking web (63) of the closing pull catcher (50) as shown in FIG. 11. The latter is at this moment in its rear position. There, it abuts, pre-tensioned by a spring in engagement with the engagement ledge (69), see FIG. 15, the cover plate edge (33) of the lock box (40). The engagement spring (78) ensures the engagement. By the movement of the release element (121), the closing pull catcher (50) is in this case pivoted clockwise about its rear edge (58). In this way, the engagement ledge (69) slides off the cover plate edge (33). The locking is eliminated, see FIG. 12.

The spring element (99), that is a coil compression spring, moves the closing pull catcher toward the lock sheet, see FIG. 13. Herein the front surface (55) slides along the support flank (154). The final stroke closing pull movement is completed when the engagement hook (82) reaches the end of the elongated opening (44), see FIG. 14. Then the door is closed.

For opening the door, the closing pull catcher (50) is moved back to its locked original position, see FIG. 10. This which is not shown in the figures—occurs for example in connection with a usual operating handle (100), whose pivot movement is transmitted to a toothed rod via a handle shaft gear segment. The toothed rod, which is for example, horizontally supported in the door fitting in the form of a pin is moved out of the door lock box upon pushing the operating handle (100) down. When the door is closed, this pin is then contacts the base of the bore (89) formed in the front face (55), see FIGS. 16 and 17. When the closing pull catcher (50) has been moved back, the pin is automatically pulled back into the door lock box by the operating handle (100) which automatically pivots upwardly.

In the FIGS. 19-28, a closing pull variant is shown, wherein, in place of a slide wedge-type closing pull catcher (50), a carriage like closing pull catcher (250) in combination with a lever drive is provided for closing a door. The closing pull catcher (250), which is for example compression spring biased, pivots a closing pull lever (260) via a push lever (270). For locking the door, the closing pull lever (260), which in this case represents the closing pull element, engages into closing pull engagement grooves (211) of the locking sheet (111). The closing pull engagement groove (211) is disposed adjacent a trigger projection (212) of the locking sheet (111). The trigger projection (212) extends for example into the door gap (3). The closing pull trap (250) is supported and guided for that purpose in the lock box (40), which, for example, is a squared carriage, which is provided at its front end with a pivot pin (252). On the pivot pin (252), the push lever (270) is supported which itself is guided in an elongated groove (251) of the closing pull trap (250). In the rear area of the trap (250), there is a dead end bore (84) which extends in areas through the elongated groove (251).

Between the rear surface of the pull to closing pull trap (250) and the lock box (40), a spring element in the form of compression spring (99) is arranged.

The push lever (270) has a load arm (271) which in the shown embodiment has a length of about a quart of the length of the lever arm (273). The engagement spring (87) acts on the end of the lever which is disposed in the elongated groove (251). The other lever end has a joint eye (274), via which the push lever (270) is linked to the closing pull lever (260).

The closing pull lever (260), see also FIGS. 27 and 28, has for example the shape of an angled lever whose front end projects from the trap opening (32). The front end in accordance with FIG. 27 is in the form of a brake web (263) which is separated from the rest of the closing pull lever (260) by a cut-out (265). The closing pull lever (260) has in the area of its other end a joint bore (266) with an oval cross-section. In the area between the joint bore (266) and the cutout (265), there is a connecting bore (267) in which a joint pin (268) is inserted for coupling with the push lever (270). Between the connecting bore (267) and the cutout (265), there is an engagement ledge (269).

The closing pull lever (260) according to FIG. 28 corresponds to a large extent to that of FIG. 27. Instead of the opening (265), it is provided at each front end with a brake lug (264). The brake lug (264) is arranged along the virtual center line of the brake web of FIG. 27.

The closing pull lever (260) is pivotally and slidably supported in the lock box (40) with its joint bore (266) disposed on a bolt (249), see FIGS. 21 and 25. The joint pin (268) of the closing pull lever (260) extends around the joint eye (274) of the push lever (270). When the door is open, the closing pull lever (260) abuts with its engagement ledge (269) a support projection (248) of the lock box (40). The closing pull lever (260) is disposed on the bolt (249) by way of the joint bore (266) in such a way that—biased by the engagement spring (87) downwardly via the push lever (270)—it abuts the stop projection (248) over a large area. At the same time, the engagement ledge (269) is biased via the spring-loaded closing pull trap and the push lever (270) in the longitudinal direction (7) of the trap against the stop projection (248). The brake web (263) does not come into contact with the trigger projection (212).

In the FIGS. 19 and 26, the brake web (263) hits the trigger projections (212) during the door closing procedure. Herein, the closing pull lever (260) is moved on the bolt (249) along the oval joint bore (266) counter to the direction (9). At the same time, the engagement ledge (269) slides off the engagement ledge (248) in a direction counter to the direction (9). The push lever (270) supported on the trap (250) pivots—with compression of the engagement spring (87)—clockwise by several angular degrees. When the respective front edges of the engagement ledge (269) and the stop projection (248) have moved past one another the engagement is no longer effective and the closing pull trap (250) is moved by the spring element (99) in the direction (7). The pivoting closing pull lever (260) abuts the trigger projection (212) which is disposed opposite the closing flank (213). The latter is—like the trigger projection (212)—a wall section of the closing pull engagement groove (211).

In accordance with FIG. 21, the door closing movement is completed when the closing pull lever (260) abuts a cover plate edge (33) of the recess (23).

For opening the door, the operating handle (100) is pivoted down, see FIG. 5, whereby the closing pull trap (250) is pulled back counter to the direction (7). The door panel (10) is then pushed open. The backward movement of the closing pull trap (250) is completed when the engagement ledge (269) slides over the stop projection (248) and is engaged thereby.

In accordance with the FIGS. 22-24, a spring-loaded opening hook (215) is provided on the locking sheet (111). The opening hook (215) serves as a closing lever catcher. The opening hook (215) is supported on a pivot pin (218) and has a hook flank (216) which partially extends around the brake web (263). When the opening hook (215) is not actuated, the hook flank (216) corresponds to the closing flank (213). The opening hook (215) is held in its closing position according to FIG. 22 by a rubber-elastic spring element (219), for example a rubber rod, which is clamped between the back of the hook and the cutout (23).

If the closing pull trap (250) is triggered while the door is open, that is, the closing pull lever (260) is in the closed position, the door can be closed in accordance with the FIGS. 23 and 24 without operating the operating handle. The outwardly pivoted closing pull lever (260) abuts during closing the head side engagement flank (217), see FIG. 23. The braking web (263) pivots the opening hook (215) to the side in a counter clockwise direction, see FIG. 24. As soon as the door is closed, the hook flank (216) slides over the brake web (263), see FIG. 22. The door is then again locked. It is possible to provide the opening hook (215) with a, for example, electromagnetic drive in order to unlock the door by remote control.

The FIGS. 29-37 show three pivot positions of a for example two-part connector or mounting hinge structure (300) as it is used mainly in connection with rabbet doors. The mounting hinge structure has a lower hinge part (301) and an upper hinge part (321).

Of course instead of two- or multi-part mounting hinge structures also chisel mount hinges, screw-on hinges combination hinges or similar may be used.

The lower hinge part (301) consists of a stepped pivot pin (302), which is attached to the door frame for example via two smooth mounting bolts (313, 314). The bolts (313, 314) extend parallel to each other. The stepped pivot pin (302) is divided into a support part (303) and a support bolt (310). The mounting bolts (313, 314) extend from the support part (303) at a right angle. From the upper front face (305) of the support part (303), the cylindrical support bolt (312) projects centrally. The annular front face (305) of the support part (303) is wave-shaped.

The upper connecter part (321) comprises a pivot tube (323) and a mounting bolt (333). The pivot tube (323) which is provided with an end wall is disposed on the support bolt (312)—when the door panel is installed. The cylindrical inner wall of the pivot tube (323) forms together with the cylindrical outer wall of the support bolt (312) a friction pivot joint.

It is also possible to provide between the support bolt (312) and the pivot tube (323) roller bearings.

The lower axially loaded annular front face (305) has for example a shape corresponding to the wave-shape of the front face (325). If the cylindrical outer wall of the support part (304) is developed, the edge of the generated surface has a wave shape in which over 360 angular degrees two raised areas and two low areas are alternately formed. In each case, a raised area and a low area form a 180° section. The two 1800 sections are for example congruent. The raised area comprises two ramps (307, 308) with different inclinations. The long ramp (307) has an inclination of 15 angular degrees whereas the short ramp (308) has an inclination of 70 angular degrees. Depending on the type of door, these inclinations may be varied by +/−10 angular degrees. The long ramp 307 serves for lifting the door panel. It extends in the shown embodiment for example over 90 angular degrees of the opening pivot movement of the door panel.

The low area is in this case, a plane (309) or, respectively, a line of the developed annular wall. The line (309) extends normal to the pivot axis (2) of the door connector. The transitions between the ramps (307, 308) with respect to one another and with respect to the line (309) are rounded.

When the door is closed, see FIGS. 29-31, the front surfaces (305, 325) of the connector or hinge structure (301, 321) are disposed in contact with each other over all of their surface areas. When the door is being opened, the surface area (325) is pivoted with respect to the surface area (305). The long ramp (327) of the pivot tube (325) slides up along the long ramp (307) of the support part (303). With increasing opening angle, the contact area between the ramps (307, 327) becomes smaller. In this procedure, the door panel is raised, see FIGS. 32-34. Here the door is opened by about 45 angular degrees. While the ramps are disposed adjacent each other, the door panel tends to pivot to the closed position because of the gravity effects.

If the door is pivoted open by an additional 45 angular degrees, see FIGS. 35-37, the lower edge of the ramp (327) slides over the upper edge of the ramp (307). Now the plane (329) is disposed on the rounded transition area between the ramps (307, 327). The door is raised by a maximum value. If the door is pivoted open further by about 80 angular degrees, if this is possible, the door is not further raised. In the latter pivot range, there is no gravity effect for changing the door panel pivot angle.

### LISTING OF REFERENCE NUMERALS

| | |
|---|---|
| 1 | Pivot door |
| 2 | Door pivot axis |
| 3 | Door gap |
| 7 | Closing pull trap movement comprising fixture (14, |
| | 24), closing movement |
| 8 | Closing pull trap movement into the fixture (14, 24), |
| | opening movement |
| 9 | Door closing direction |
| 10 | Door panel |
| 11 | Overlay |
| 13 | Cut-out |
| 14 | Door fixture, fixture, lock cover with lock box |
| 18 | Outer door surface |
| 20 | Door frame |
| 23 | Recess |
| 24 | Frame fixture, fixture, locking box |
| 25 | Trap opening |
| 26 | Locking bolt opening |
| 27 | Mounting bores |
| 29 | Door seal |
| 30 | Final door closing pull mechanism |
| 31 | Cover plate |
| 32 | Catcher opening |
| 33 | Lock box cover plate, engagement stop |
| 34 | Mounting bores |
| 40 | Lock box |
| 41 | Box cover |
| 42 | Lock cover |
| 43 | Guide web |
| 44 | Elongated hole |
| 45 | Stop, web-like |
| 46 | Blocking flank |
| 47 | Engagement edge |
| 48 | Bore for (103) |
| 49 | Stop bolt |
| 50 | Closing pull catcher |
| 51 | Upper side |
| 52 | Bottom side |
| 53 | Lock bottom side |
| 54 | Lock cover side |
| 55 | Front surface, front (possibly closing flank) |
| 56 | Rear surface |
| 57 | Tip |
| 58 | Edge, rear |
| 61 | Head section |
| 62 | Connecting web |
| 63, 64 | Braking web, braking bolt |
| 65, 66 | Recesses |
| 67, 68 | Walls, braking surfaces |
| 69 | Engagement ledge |
| 71 | Center section |
| 72 | Cut-out |
| 73 | Front flank |
| 74 | Elongated damper opening |
| 75 | Grooves |
| 76 | Elongated cam hole |
| 77 | Release ramp, ledge, ramp-shaped |
| 78 | Dead end bore for (86) |
| 79 | Counter surface, or closing flank |
| 81 | Foot section |
| 82 | Stop hook |
| 83 | Rear flank |
| 84 | Dead end bore for (87) |
| 85 | Support plate |
| 86 | Engagement spring, front; compressor coil spring |
| 87 | Engagement spring, rear; compression coil spring |
| 88 | Dead end bore for (99) |
| 89 | Stepped bore |
| 90 | Damper |
| 91 | Cylinder |
| 92 | Piston |
| 93 | Piston front plate, piston |
| 94 | Piston rod |
| 98 | Return spring |
| 99 | Spring element compression spring, pull spring |
| 100 | Operating handle |
| 101 | Square bolt |
| 103 | Pivot nut |
| 104 | Nut cam |
| 105 | Square opening |
| 106 | Outer wall, cylindrical |
| 108 | Chain spring |
| 109 | Spring support |
| 110 | Closing pull mechanism counter piece |
| 111 | Angled locking sheet, closing sheet |
| 112 | Catcher engagement element |
| 113 | Front side |
| 115 | Closing pull trap recess |
| 116 | Nut for (63, 64) |
| 117 | Nut for (167, 168) |
| 118 | Cutout |
| 121, 122 | Trigger element, tongue-shaped |
| 123 | Contact flank |
| 153 | Support flank on (121, 122) |
| 154 | Support flank on (111) |
| 160 | Closing pull element |
| 167, 168 | Walls, closing pull flanks |
| 210 | Closing pull mechanism counter piece for lever drive |
| 211 | Closing pull engagement groove |
| 212 | Trigger projection, trigger element |
| 213 | Closing flank |
| 215 | Opening hook, closing lever catcher element |
| 216 | Hook flank |
| 217 | Engagement flank |
| 218 | Pivot pin |
| 219 | Spring element, rubber rod |
| 230 | Final closing pull mechanism with lever drive |
| 248 | Stop projection |
| 249 | Bolt |
| 250 | Closing pull catcher |
| 251 | Elongated groove |
| 252 | Pivot pin |
| 260 | Closing pull lever, closing pull element |
| 263 | Brake web |
| 264 | Brake pin |
| 265 | Cut-out |
| 266 | Joint bore, oval in cross-section |
| 267 | Linking bore |
| 268 | Joint pin |
| 269 | Engagement ledge |
| 270 | Push lever |
| 271 | Load arm |
| 272 | Joint eye, center |
| 273 | Lever arm |
| 274 | Joint eye, front |
| 300 | Connector or hinge |
| 301 | Connector part bottom |
| 302 | Pivot pin, stepped |
| 303 | Support part |
| 305 | Front face |
| 307 | Ramp, long |
| 308 | Ramp, short |
| 309 | Plane, line |
| 312 | Support bolt |
| 313, 314 | Mounting pin, smooth |
| 321 | Connector top |
| 323 | Pivot tube |
| 325 | Front face |
| 327 | Ramp, long |
| 328 | Ramp, short |
| 329 | Plane, line |
| 333 | Mounting bolt with outer thread |

What is claimed is:

1. A door closing mechanism of a hinged door (1) disposed in a door frame (20), comprising a door fixture (14) mounted in, or on, a door panel (10), a frame fixture (24) mounted in, or on the door frame (20), a final door closing pull mechanism (30, 230), which is arranged in the door fixture (14) or the frame fixture (24) and a closing pull mechanism counter part (110, 210) which is arranged in the frame fixture (24) or, respectively, the door fixture (14),
the final door closing pull mechanism (30, 230) including a closing pull catcher (50, 250) to which a closing pull element (160, 260) is attached,
the closing pull catcher (50, 250) being supported in the fixture (14) or (24) so as to be movable therein by a spring element (99) into a front position in which it is retained, and
the closing pull mechanism counter piece (110, 210) having at least one trigger element (121, 212) which is directly or indirectly contacted by the closing pull element (160, 260) during closing of the door (1) in order to fully close the door (1) by a sliding movement of the closing pull catcher (50, 250) in combination with the closing pull element (160, 260).

2. A door closing mechanism according to claim 1, wherein the closing pull element (160) includes—as part of a wedge drive—a wedge-like shaped area of the closing pull catcher (50) which, when the door is closed, abuts a trigger element (121, 122) by one of a point-, line- and area contact.

3. Door closing mechanism according to claim 1, with a final closing mechanism arranged on, or in, the door panel (10), wherein the closing flank (79) of the closing pull catcher (50) has a surface-normal line whose direction deviates from the direction (9) of the door closing movement by 15-75 angular degrees, wherein the surface-normal line can be split into two components which extend perpendicularly to each other and of which one is directed opposite to the direction (9) of the door closing movement, whereas the other is directed at least approximately in the direction (7)—that is away from the pivot bearing of the door panel (10).

4. Door closing mechanism according to claim 1, with a final closing arrangement arranged in, or on, the door frame (20), wherein the closing flank (55) of the closing pull catcher (50) has a surface-normal line, whose direction differs from the direction (9) of the door closing movement by 15-75 angular degrees, wherein the surface normal line can be split into two components which extend normal to each other, and one of which points in the direction (9) of the door closing movement whereas the other points at least approximately in the direction of the pivot support bearing of the door panel (10).

5. Door closing mechanism according to claim 1, wherein the direction of closing movement (7) is disposed in a plane, which is oriented normal to the pivot axis of the door panel.

6. Door closing mechanism according to claim 1, wherein the direction of closing movement (7) is parallel to the outer door surface (18).

7. Door closing mechanism according to claim 1, wherein the closing pull catcher (50) comprises two braking webs (63, 64) which are oriented parallel to the pivot axis of the door and which have free ends which are spaced farthest from each other.

8. Door closing mechanism according to claim 1, wherein the door fixture (24) is or includes a catcher engagement element (112), wherein the catcher engagement element (112) has two trigger element (121, 122) which are oriented parallel to the pivot axis of the door and whose free ends face each other.

9. Door closing mechanism according to claim 1, wherein the closing pull catcher (50) is supported and guided in a lock box (40).

10. Door closing mechanism according to claim 9, wherein the closing pull catcher (50) is lockable in the lock box (40) in a front and in a rear position by means of two engagement stops (33, 45) and two compression springs (86, 87).

11. Door closing mechanism according to claim 1, wherein the final door closing mechanism (30, 230) includes one of a mechanical, a pneumatic and a hydraulic damper member (90) which is arranged between the closing pull catcher (50) and the fixture (14) or (24).

12. A door closing mechanism for a hinged door (1) arranged in a door frame (20), comprising a door fixture (14) arranged in, or on, a door panel (10), a frame fixture (24) arranged in, or on, the door frame (20), a final door closing pull mechanism (20, 230) arranged in the door fixture (14) or in the frame fixture (24) and a closing pull arrangement counter part (110, 210) which is arranged in the frame fixture (24), or respectively, in the door fixture (14),
wherein the final door closing pull arrangement (30, 230) includes a closing pull catcher (50, 250), to which a closing pull element (160, 260) is attached,
wherein the closing pull catcher (50, 250) is supported in the fixture (14) or (24) and is moveable therein by a spring element (99) into a front position in which it is retained,
wherein the closing pull arrangement counter piece (110, 210) has at least one trigger element (121, 212) which is directly or indirectly contacted by the closing pull element (160, 260) during closing of the door (1) in order to close the door (1) by the sliding movement of the closing catcher (50, 250) in combination with the closing pull element (160, 260),
wherein the closing pull catcher is provided with at least one brake surface (67, 68),
wherein the final door closing pull arrangement (30, 230) includes a damper member (90) which is arranged between the closing pull catcher (50) and one of the door fixture (14) and the frame fixture (24), and
wherein the trigger element (121, 212) includes at least one contact flank (123) with which the braking area (67, 68) comes directly or indirectly into contact during closing of the door in order to brake the closing movement of the door panel (10) by the operation of the damper member (90).

13. A door closing mechanism according to claim 11, wherein the damper member (90) damps the closing pull catcher movement which is executed by the closing pull catcher (50) during movement out of the lock box (40).

14. A door closing mechanism according to claim 12, wherein the damper member (90) is based on a mechanical pneumatic or hydraulic operating principle.

15. A door closing mechanism according to claim 1, wherein the hinged door (1) is supported on the door frame (20) or the wall supporting the hinged door in at least two door hinges (300) which consist of at least two parts.

16. A door closing mechanism according to claim 15, wherein the individual door hinge (300) comprises a lower hinge part (301) and an upper hinge part (321) wherein the lower hinge part (301) has a front face area (305) and the upper hinge part has a front face area (325) and both are annular front face areas (305, 325), which are wave shaped and disposed on one another for lifting the hinged door when it is pivoted open.

17. A door closing mechanism according to claim 16, wherein the wave shape of the upper front face area (325) fits onto the wave shape of the lower front face area (305) when the door is closed.

18. A door closing mechanism according to claim 16, wherein each wave shape is at least one development of a plane (309, 329) of a long and flat ramp (307, 327) and a short and steep ramp (308, 328), wherein the inclination of the long ramp (307, 327) is between 10 and 40 angular degrees and the inclination of the short ramp (309, 329) is between 60 and 90 angular degrees.

19. A door closing mechanism according to claim 16, wherein, in at least one position of the open pivot door (1), the transition points between the ramp (307, 308, 327, 328) are in contact with the planes (329, 309).
